(19) United States
(12) Patent Application Publication
(10) Pub. No.: US 2009/0190043 A1
(43) Pub. Date: Jul. 30, 2009

(54) Single panel projection system

(76) Inventors: Manlin Pei, Valencia, CA (US); Yong-Jing Wang, Valencia, CA (US)

Correspondence Address: ALBERT O COTA, 5460 WHITE OAK AVE, SUITE A-331, ENCINO, CA, 91316, US

(21) Appl. No.: 11/789,957

(22) Filed: Apr. 26, 2007

Related U.S. Application Data
(60) Provisional application No. 60/745,940, filed on Apr. 28, 2006.

(51) Int. Cl. H04N 5/64; G09G 3/32

(52) U.S. Cl. 348/744; 345/82; 348/E05.128

(57) ABSTRACT

A single panel projection system that comprises an illumination system which produces spatially separated color illumination segments. A display panel having at least two segments displays corresponding color information, which is aligned with the corresponding color illumination segments. A projection lens system combines the at least two segments together into a full color picture by using an angular-color-mixing technique. The system comprises only a single panel, therefore the system cost is lower than that of other three panel systems. The system has no moving color filter, so color artifacts related to color sequential method are eliminated. Color energy is distributed to three color segments at any time, therefore the light efficiency is high.

This application claims priority of Provisional Patent Application No. 60/745,940 having a filing date of Apr. 28, 2006.

### TECHNICAL FIELD

The invention generally pertains to projection display systems and more particularly to a new color projection display system using a single display panel and a new color management mechanism.

### BACKGROUND ART

Projection displays have been widely used in consumer and professional markets because they can produce better image quality at a lower cost than direct view display technologies. All projection systems comprise a micro display panel to generate a picture, an illumination system to illuminate the micro display panel, and a projection lens system to enlarge the picture. However, all micro display panels are monochrome and require a method for producing color. There are several methods to produce color:
1) A three-panel structure method which utilizes three panels to generate three sub-frame pictures of three primary colors. A color combination prism is used to merge each color sub-frame into a color frame. The three-panel structure method is expensive since three micro display panels are used. Additionally, it is also very difficult to accurately align the three-panels together during the assembly of optical engines. Almost all high temperature polysilicon (HTPS) micro display systems and most transmissive liquid crystal on silicon (LCOS) micro display systems utilize this method.
2) A color sequential method which utilizes one panel illuminated by time-sequential colored lights to generate a color picture. This method is simpler and costs less than the three-panel structure method, but has to work with an electronic system of high data bandwidth and a display panel with a fast response time. As a consequence, the system cost of this method is also high. Moreover, sequential color cuts off two-thirds of the white light, therefore its optical efficiency is low. Color artifacts are also a problem. Most consumer projection televisions are based on digital light processing (DLP) and some projection systems based on LCOS utilize the color sequential method.
3) A color filter method which is widely used in a direct viewing display. It can also be used in a projection system. Three sub-pixels covered by a red-green-blue color filter form a full pixel. There are many hurdles for a micro display panel with color filters in a projection system. First, the color filter is difficult to construct on the backplane of a micro display panel. The filter requires an additional manufacturing process when used in a LCOS system so its yield is low. The color filter method is almost impossible to utilize in a DLP based system. Additionally, the interaction between the color filter material and liquid crystal under a high light load makes the lifetime of the panel very short, and the light efficiency is low since two-thirds of the light energy is lost.

Single panel projection systems are also known which employ a color combination prism (aka color cube), however this method has never been commercialized. For example, there is a system which employs multiple color segments in a single panel, prisms to redirect the color beams, and a color combination mechanism to converge the three color segments into one color image. However, this system has the following problems:

1) The light paths for three color channels are different. To compensate for the different light paths, prisms made of a material other than air is needed. A light beam with a certain cone angle will undergo multiple reflections and therefore produce multiple images. To avoid multiple reflections, a substantially collimated beam is required, i.e. light beams with very small cone angles are needed. This will greatly reduce the brightness of the projection system.

2) The color segments can not be placed substantially close to each other, i.e. buffer zones are required between color segments. Otherwise, there will be color cross talk between each color channel. This also means the overall size of the display panel has to be more than three times that of a single panel. The price advantage of single panel structure is totally eliminated.

3) The prisms and color cube make the system more expensive and difficult to manufacture. All these drawbacks make this system even more expensive and less attractive than a traditional three panel system.

As a result, there exists a current need for a simple, low cost and compact single panel projection system.

A search of the prior art did not disclose any patents that read directly on the claims of the instant invention, however the following U.S. patents are considered related:

| PATENT NO. | INVENTOR | ISSUED |
|---|---|---|
| 6,947,020 | Kiscer et al | 20 Sep. 2005 |
| 6,057,894 | Kobayashi | 2 May 2000 |

The U.S. Pat. No. 6,947,020 patent discloses a multi-array spatial light modulating (SLM) device and methods of fabricating such a device. The multi-array SLM device includes a number of addressable arrays of elements, and each of the addressable arrays is capable of modulating light to generate an image.

The U.S. Pat. No. 6,057,894 patent discloses a projection liquid crystal display that utilizes a dichroic prism for separating a light to provide fundamental colors for a color display. The patent also discloses a unit for enlarging and projecting a transmitted light from a liquid panel. The liquid panel has one surface fixedly attached to a transparent member and the other surface integral with the dichroic prism directly or through at least one optical component.

For background purposes and as indicative of the art to which the invention is related reference may be made to the remaining patents located in the search:

| PATENT NO. | INVENTOR | ISSUED |
|---|---|---|
| 7,083,288 | Yamanaka | 1 Aug. 2006 |
| 6,637,888 | Haven | 28 Oct. 2003 |
| 6,535,256 | Ishihara et al | 18 Mar. 2003 |
| 6,334,685 | Slobodin | 1 Jan. 2002 |
| 6,219,110 | Ishikawa et al | 17 Apr. 2001 |

### DISCLOSURE OF THE INVENTION

The present invention uses a single display panel and a new color management system to produce color pictures. This invention, a new single panel projection display system comprises:

1) an illumination system,

2) a color splitting system that can produce spatially separated color illumination areas from the illumination system,

3) a display panel with at least two segments that display information pertaining to corresponding colors, which are aligned with the corresponding color illumination segments, and

4) a projection lens system that can combine the color segments together into a full color picture by using an angular-color-mixing technique.

Accordingly, there are several objects or advantages of the invention compared with existing three-panel structures. The objects or advantages are:

(a) to reduce the cost of the display panels since there is only one panel,

(b) to remove the alignment difficulty by using only one panel, and

(c) to reduce related light engine cost by replacing complex color management components with an angular-color-mixing technique.

Further objects and advantages compared with existing single panel structures are:

(a) to increase the light efficiency,

(b) to eliminate color artifacts,

(c) to reduce the bandwidth requirement for driving electronics and response time of display panels, and

(d) to remove the color filter in the panel, thus reducing the cost of the panel and increasing the panel's lifetime and reliability.

Still further objects and advantages will become apparent from the following description and accompanying drawings. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

FIG. 1 is a schematic diagram of the first embodiment of the present invention wherein a reflective LCD panel or an LCOS reflective panel is used as a display panel.

FIG. 2 is a schematic diagram of the second embodiment of the present invention wherein the display panel consists of three transmissive display panels.

FIG. 3 is a schematic diagram of the third embodiment of the present invention wherein a reflective MEMS panel is used as the display panel.

FIG. 4 is a schematic diagram of the fourth embodiment of the present invention wherein an emitting panel is used as the display panel.

FIG. 5A is a schematic diagram of an LED illumination system utilizing direct coupling.

FIG. 5B is a schematic diagram of an LED illumination system utilizing lens coupling.

FIG. 5C is a schematic diagram of an LED illumination system utilizing light pipe coupling.

FIG. 6 is a schematic diagram of a near-to-eye virtual display system.

FIG. 7 is a schematic diagram of projection display system having at least two panels arranged substantially adjacent to each other and substantially on the same plane.

FIG. 8A is a schematic diagram of a projection lens showing tilted dichroic mirrors.

FIG. 8B is a schematic diagram of a projection lens showing a display panel having two field lenses.

FIG. 9A is schematic diagram showing three tilted dichroic mirrors having three substrates.

FIG. 9B is a schematic diagram showing three tilted dichroic mirrors having two optical wedges placed together.

FIG. 9C is a schematic diagram showing a substrate and three dichroic mirrors having two optical wedges having similar angles with the apex of each wedge in close proximity.

FIG. 9D is a schematic diagram showing three dichroic mirrors having mechanical parts to control the tilting angles.

FIG. 10 is a schematic diagram of projection lens using grating or hologram components.

FIG. 11 is a schematic diagram of illumination system, where dichroic mirrors and light pipes are used to generate side by side color illuminations.

FIG. 12 is schematic diagram of a projection lens.

### BEST MODE FOR CARRYING OUT THE INVENTION

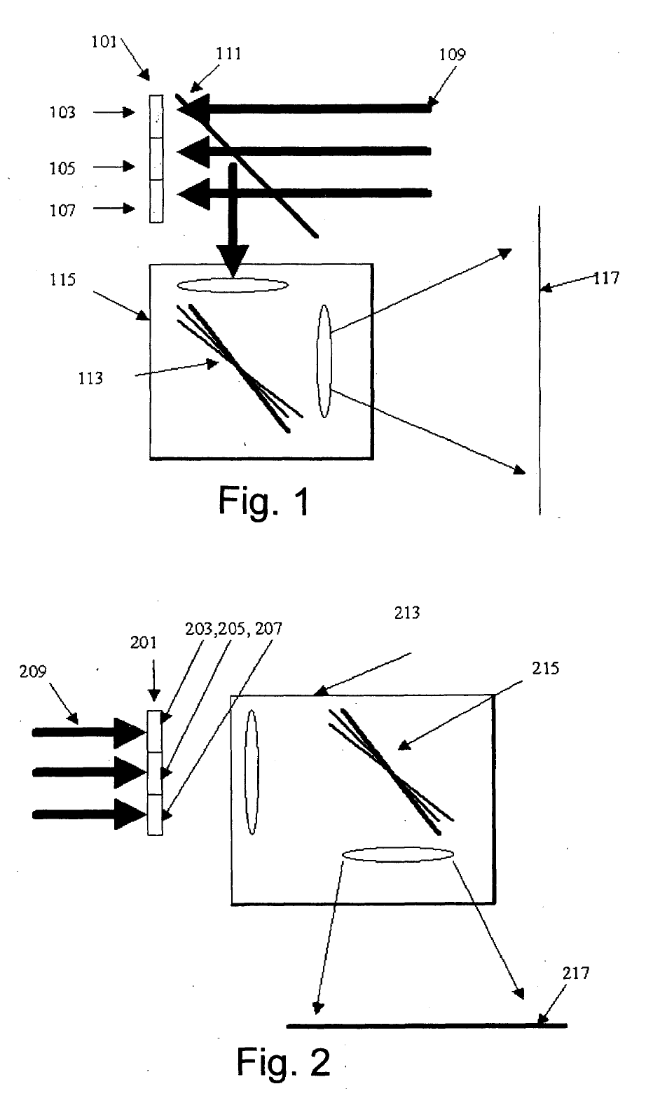

The best mode for carrying out the invention is presented in terms of first, second, third, fourth, fifth and six embodiments, with several design configurations, for a single panel projection system (hereinafter “SPPS”). As shown in FIG. 1, the first embodiment of the SPPS is comprised of a reflective display panel 101, which is typically a liquid crystal on silicon (LCOS) panel that displays information pertaining to at least two colors in different segments 103, 105, 107. An illumination system 109 illuminates the reflective display panel 101 with spatially separated color beams. Each color beam corresponds to a specific display segment. A polarization beam splitter 111 redirects the reflected light into a light collection/projection system 115. There are at least two dichroic mirrors 113 in the light collection/projection system that tilt, thereby causing the different color beams to tilt at different angles so that pictures in different colors are combined together to form a full color picture on a screen 117.

As shown in FIG. 2, the second embodiment of the SPPS is comprised of a transmissive display panel 201. The panel 201 is typically a high temperature polysilicon (HTPS) panel, liquid crystal diode (LCD) panel, a thin-film transistor (TFT) LCD panel, or a transmissive liquid crystal on silicon (LCOS) panel. The panel 201 has at least two spatially separated segments 203, 205, 207 that display information pertaining to corresponding colors. An illumination system 209 illuminates the transmissive display panel with spatially separated color beams, with each color beam corresponding to a specific display segment. A light collection/projection system 213 projects the picture onto the screen 217. There are at least two dichroic mirrors 215 in the light collection/projection system. The mirrors 215 tilt at different angles so that pictures in different colors are combined together to form a full color picture on a screen 217.

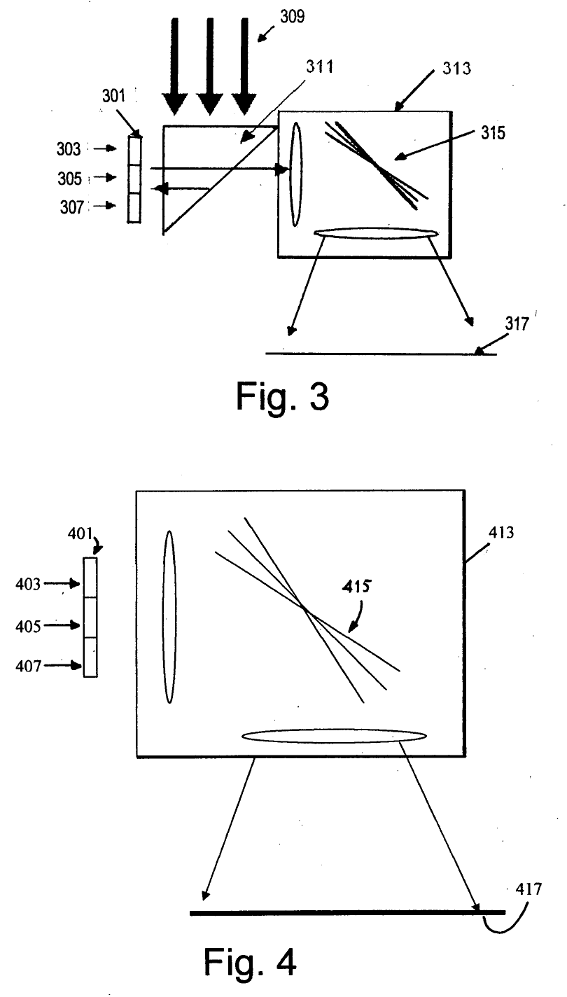

As shown in FIG. 3, the third embodiment of the SPPS is comprised of a reflective display panel 301, which is typically a micro-electro mechanical system (MEMS) panel that modulates the light by tilting micro mirrors. For example, a digital light processing (DLP) panel that displays information pertaining to at least two colors in at least two different segments 303, 305, 307. An illumination system 309 illuminates the MEMS display panel with corresponding spatially separated color beams, with each color beam corresponding to a specific display area. A total internal reflection (TIR) prism or other optical set-up 311, which are well known to those skilled in the art, separates the incident beam and the reflected beam. A light collection/projection system 313 projects the picture onto a screen 317. There are at least two dichroic mirrors 315 in the light collection/projection system. The mirrors 315 tilt at different angles so that pictures of different colors are combined together to form a full color picture on a screen 317.

The functions of the illumination system and the display panel in the above embodiments can be integrated together into a single emitting display panel.

As shown in FIG. 4, the fourth embodiment of the SPPS is comprised an emitting display panel 401, which is typically an LED panel, an organic-LED panel or other emitting display technology that is known to those skilled in the art. The panel 401 has at least two segments 403, 405, 407 that displays information pertaining to at least two colors. A light collection/projection system 413 projects the color pictures onto a screen 417. There are at least two dichroic mirrors 415 in the light collection/projection system. The mirrors 415 tilt at different angles so that pictures of different colors are combined together to produce a full color picture on a screen 417.

The illumination system in the above embodiments can operate with LEDs or lasers instead of a traditional incandescent or an arc lamp.

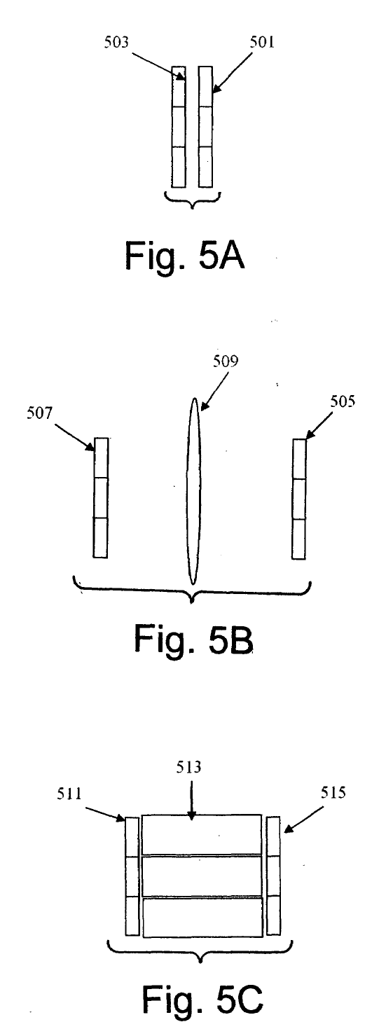

The fifth embodiment of the SPPS comprises an illumination system consisting of a plurality of LED chips, as shown in FIGS. 5A-5C. The LED chips 503, 507, 511 have at least two color emitting segments in one chip. In another embodiment, the LED chips 503, 507, 511 comprise at least two sub-chips that are aligned substantially close to each other. The light energy from the LEDs is coupled onto display panels 501, 505, 515 by direct coupling, as shown in FIG. 5A; lens coupling, as shown in FIG. 5B; or by light pipe coupling, as shown in FIG. 5C. The display panels can be any transmissive or reflective panels as described in the above embodiments. Lens coupling can be used in reflective panel systems. The LED chips 507 and coupling lens 509 form an illumination system that works together with other components in the first, second and the third embodiments. The coupling lens, aka relay lens, comprises one or more lenses.

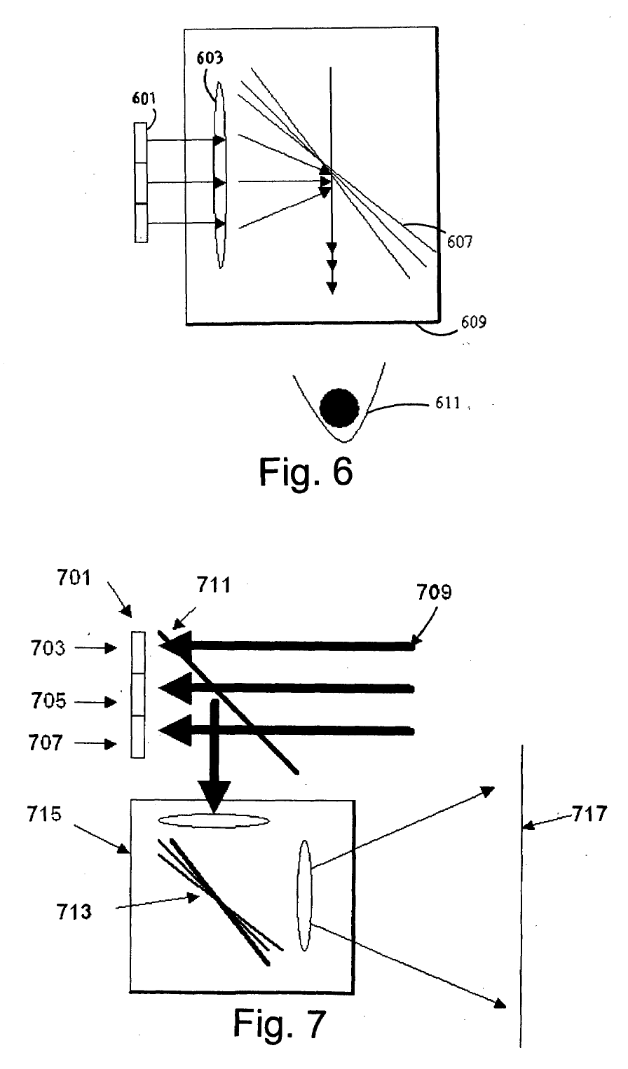

The display panels in the above embodiments can be replaced by a viewer's eyes for near-to-eye applications. In a sixth embodiment, a new near-to-eye virtual display system comprises an illumination system (not shown), a reflective or transmissive display panel 601, and a light collecting system 609 having at least two dichroic mirrors 607, as shown in FIG. 6. The dichroic mirrors 607 tilt the beams at different angles to form a convergent red green blue beam. The light collection system 609 produces a full color image visible to a human eye 611. The illumination system in the above embodiments is selected from the group consisting of an incandescent lamp, an arc lamp, an LED light source and a laser light source. Alternatively, the display panel in the above embodiment is comprised of a self-emitting panel such as an LED or OLED panel.

Alternatively, the display panel in the above embodiments can have at least two panels that are aligned substantially close to each other instead of a single panel having multiple color segments. The at least two panels can be reflective, transmissive or self emitting. FIG. 7 shows an embodiment of separated reflective LCOS panels. Those skilled in the art should also realize that the display panel on all the proceeding embodiments can consist of at least two panels aligned substantially close to each other instead of a single panel. Such equivalent constructions do not depart from the spirit and scope of the invention in its broadest form.

There are many alternative forms of projection lenses. At least two dichroic films are made of multi-player coating, or other selective reflective materials are inserted into the projection lens to combine the pictures in different colors to form a full color image. The position of the dichroic mirror can be in front of, within or after the main projection lens. Those skilled in the art should appreciate that there are many different forms of projection lenses. Those skilled in the art should also realize that such equivalent constructions do not depart from the spirit and scope of the invention in its broadest form.

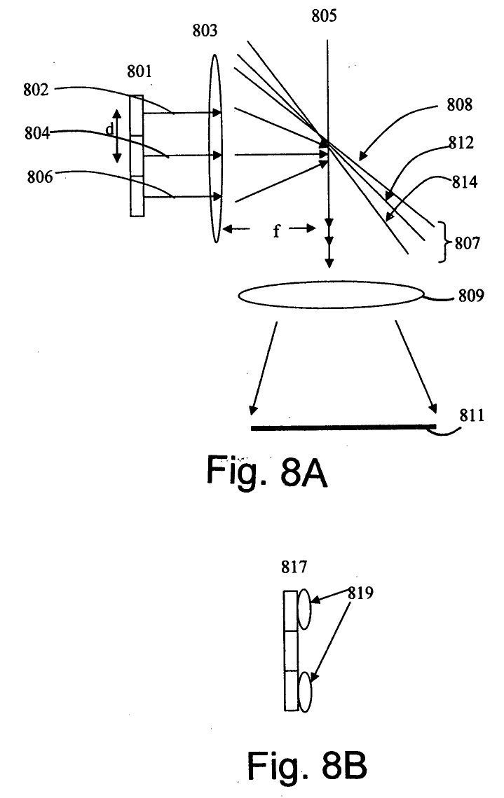

An embodiment of the projection lens is shown in FIG. 8A. The light coming from a display panel 801 passes through a lens unit 803, having at least one lens with an effective focal length of f. The different color segments of the panel 801 are shifted by a distance of d. At the focal plane 805 of the lens unit, the different color lights 802, 804, 806 are separated by an angle that is less than 90 degrees and, which is determined by a tan(d/f).

Since the different color pictures are at different heights, the color pictures will be encoded by angles. The dichroic mirrors 807 are placed at the plane 805 to decode the angular information. There are at least three dichroic mirrors 808, 812, 814 tilting at different angles. The dichroic mirror 808 only reflects the color light 802 and transmits the other color lights. The dichroic mirror 812 only reflects the color light 804 and transmits the other color lights. The dichroic mirror 814 only reflects color light 806 and transmits the other color lights.

The tilting angles between the dichroic mirrors are determined by a tan(d/f)/2, therefore different color pictures are redirected at the same angle. Finally, the second lens unit 809 with at least one lens projects the picture onto a screen 811 to form a full color image.

The tilted dichroic mirrors will cause image distortion, such as keystone distortions. To insure that the red, green and blue (R G B) color images converge together, the distortion should be corrected. In one embodiment, the distortion is corrected electronically. An image processor pre-processes the R G B images to add pre-distortion onto them. This distortion will be compensated by the distortion caused by the optical system to produce a substantially distortion-free image.

The distortion can also be corrected by optical methods. In an embodiment shown in FIG. 8B, field lenses are placed substantially close to the display panel. Only the display panel 817 and fielded lenses 819 are shown. The illumination system and light collection system are not shown for simplicity. The field lenses can be concave lenses, convex lenses, Fresnel lenses or even aspherical lenses. The field lenses are tilted and shifted at a specific angle to correct the distortion. The field lenses can also be a glass wedge or a prism with a certain angle to correct the distortion.

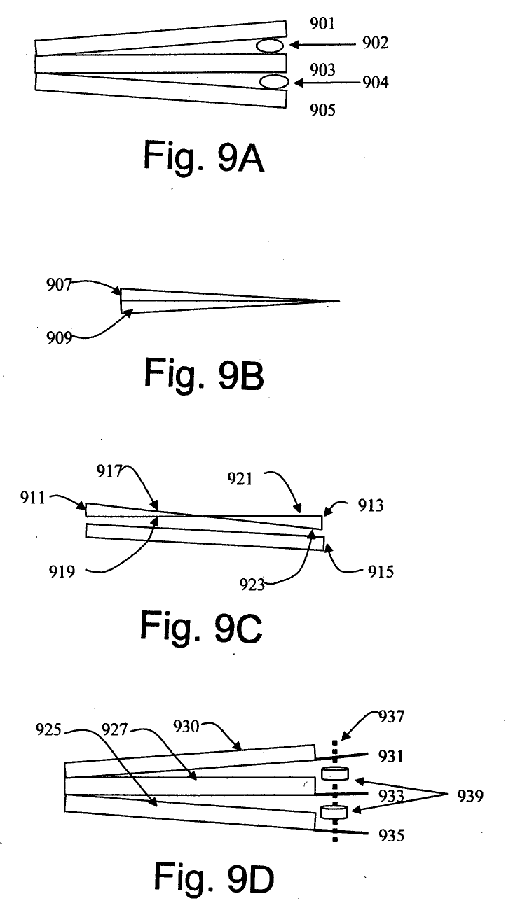

The dichroic mirrors in the above embodiments can be arranged in various designs. In one design, as shown in FIG. 9A, three substrates 901, 902, 903 are tilted with one of their ends substantially close to each other, and the opposite ends apart from each other. The amount of tilting is adjusted to reflect the incident color beams from different angles to the same direction. Filling material such as glue 902, 904 is inserted between the substrates to control the tilting angles. At least one side of each substrate has a dichroic mirror coating. Another side has an antireflection coating to reduce residual reflections. In FIG. 9B, two optical wedges 907, 909 are placed together with one face substantially close to each other. Three of the four surfaces of the two wedges are coated with a dichroic mirror coating. The fourth surface is coated with an antireflection coating. The cross angles of the wedge are designed to reflect the incident color beams from different angles in the same direction. In FIG. 9C, two optical wedges 911, 913 with the same angle are arranged with the apex substantially close to each other. One face 917 of the wedge 911 is placed on the extension plane of the face 923 of the wedge 913. Another face 919 is in line with the face 921 of the wedge 913. The faces 917, 923 are both coated with the same color dichroic coating. The faces 919, 921 are both coated with the same dichroic coating of the other color. The cross angle of the wedges 911, 913 are designed to converge the top color segment and bottom color segment to the center color segment. The substrate 915 has a dichroic coating on at least one face. Another face has anti-reflection coating. The distance between the wedges 911, 913 and the face 923 can be adjusted to compensate for the light path difference among the three color channels. In FIG. 9D, at least two dichroic substrates 925,927,930 are mounted with frames 931,933,935. These frames are mounted to an axis 937. Screw knobs 939 on the axis 937 are used to control the tilting angle. Those skilled in the art should appreciate that there are many different forms of optical layouts to arrange one or more dichroic mirrors at different angles. These different arrangements do not depart from the spirit and scope of the invention in its broadest form. Those skilled in the art should also appreciate the need for other mechanical parts or methods, such as adjustment screw and glues, to adjust or mount all the optical substrates and wedges. These different mechanical forms do not depart from the spirit and scope of the invention in its broadest form.

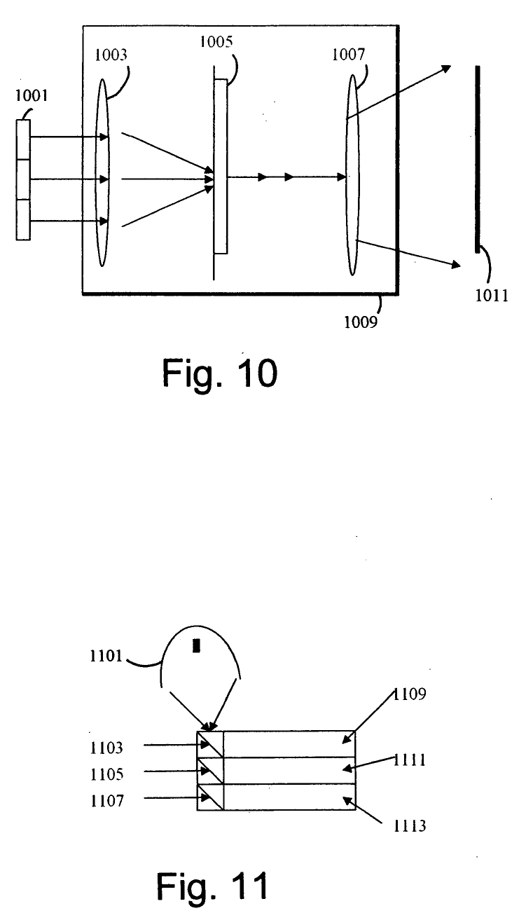

In another design configuration, as shown in FIG. 10, the dichroic mirrors can be replaced by other color selective refraction/diffraction/reflection components, such as a grating or a hologram. In this design configuration, the projection system comprises an illumination system (not shown), a reflective or transmissive display panel 1001, a light collecting system 1009 with first projection lens unit 1003, a hologram film 1005 and second projection lens units 1007. The hologram film tilts the beams at different angles to form a convergent red green blue beam. The light collection system 1009 produces a full color image on the screen 1011. In this design configuration, the light path can be bended 90 degrees or be a straight light path.

The illumination system in the above design configuration can be any system that produces at least two color segments. Dichroic color filters can also be used in serial to split the input white beam into RGB color segments with substantially little light loss. In another design configuration, as shown in FIG. 11, the light from a lamp 1101 is focused on a cubical prism 1103 by a reflector or focus lenses. There is dichroic coating on the hypotenuse of the cubical prism 1103, which reflects one primary color and transmits the other two primary colors. One color light is reflected into a light pipe 1109, which homogenizes the light to form a segment of color illumination. The rest of the color light passes onto a second cubical prism 1105. There is other dichroic coating on the hypotenuse of the cubical prism 1105. The other color light is reflected into a light pipe 1111, which homogenizes the light to form the other segment of color illumination. The rest of color light passes onto a third cubical prism 1107. There is other dichroic coating on the hypotenuse of the cubical prism 1107. The other color light is reflected into a light pipe 1113, which homogenizes the light to form the other segment of color illumination.

In another design configuration, a color filter with spatially separated color segments can be used in the illumination path or on the top of the display panel to generate at least two color illumination segments. In this case, two-thirds of the light energy is lost. Those skilled in this field should know that the illumination system can comprise relay lenses, dichroic mirrors, or prisms to form an illumination light path within air, or can comprise light pipe, dichroic coatings, and prisms to form an illumination light path based on a light guide. Those skilled in the art should also realize that such equivalent constructions do not depart from the spirit and scope of the invention in its broadest form.

In another design configuration, the illumination comprises a light source and a diffraction element such as a grating or hologram. The different color light is diffracted into different angles or positions to form different color illumination segment simultaneously.

Those skilled in the art should appreciate that there are many different forms of the illumination system, the display panel, and the projection lens. Those skilled in the art should realize that different combinations of these components do not depart from the spirit and scope of the invention in its broadest form.

In all the above embodiments, three primary color systems are used. Those skilled in the art should realize all embodiments are also applicable to other color systems, such as four, five or even more primary color systems by using more than three color segments on the display panels. In all the above embodiments, side by side color segment arrangement is used. Those skilled in the art should realize there exist other forms of color arrangement, such as delta arrangement.

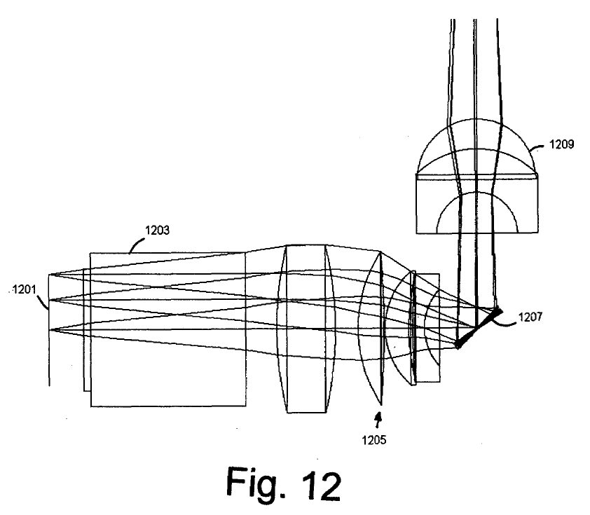

An example of a projection lens is shown in FIG. 12. The display panel 1201 has one or more segments displaying a picture in different colors. Element 1203 is the polarization beam splitter that can separate the illumination light path (not shown) and projection light path. The element 1205 is the first lens unit of the projection lens. Three dichroic mirrors 1207 are placed substantially close to the focal plane of 1205. The dichroic mirrors 1207 are tilted at different angles to converge the color pictures in the same direction. The second lens unit 1209 of the projection lens then projects the color pictures onto a screen.

1. A single panel projection system comprising:
a) a display panel having at least two segments that display corresponding color information or at least two display panels that are arranged substantially adjacent to each other on the same plane,
b) an illumination system that produces spatially separated illumination segments, and
c) a projection lens having means for combining at least two segments into a color picture.

2. The single panel projection system as specified in claim 1 wherein said projection lens system comprises at least two dichroic mirrors that are tilted at different angles, wherein the angles are less than 90 degrees.

3. The single panel projection system as specified in claim 2 wherein said projection lens comprises parameters that are determined by:
a) color segments being shifted by a distance of d,
b) a first lens unit having at least one lens with an effective focal length of f,
c) dichroic mirrors being placed on the effective focal plane of the first lens unit, and
d) a tilting angle determined by a tan(d/f)/2, which is less than 90 degrees.

4. The single panel projection system as specified in claim 2 wherein said projecting lens comprises optical components that correct the distortion caused by the tilting of the dichroic mirrors.

5. The single panel projection system as specified in claim 4 wherein the optical components comprise tilting or shifting field lenses that are comprised of glass or Fresnel lens.

6. The single panel projection system as specified in claim 4 wherein said optical components are comprised of an optical prism or wedge.

7. The single panel projection system as specified in claim 2 wherein said dichroic mirrors are located before, within or after said projection lens system.

8. The single panel projection system as specified in claim 2 wherein the display panel comprises electronic image processing that corrects the distortion caused by the tilting dichroic mirrors.

9. The single panel projection system as specified in claim 1 wherein said display panel is selected from the group consisting of a reflective LCOS panel, a transmissive LCOS panel, a MEMS panel, a HTPS panel, and a TFT LCD panel.

10. The single panel projection system as specified in claim 1 wherein said illumination system is selected from the group consisting of an incandescent lamp, an arc lamp, an LED light source, and a laser light source.

11. The single panel projection system as specified in claim 1 wherein said illumination system comprises dichroic mirrors arranged in series or in parallel.

12. A single panel projection system comprising:
a) an emitting display panel having at least two segments that display corresponding color information, or at least two emitting display panels that are located substantially adjacent to each other and substantially on the same plane, and
b) a projection lens having means for combining said at least two segments together to form a full color picture.

13. The single panel projection system as specified in claim 12 wherein said projection lens comprises at least two dichroic mirrors that are tilted at different angles, wherein the angles are less than 90 degrees.

14. The single panel projection system as specified in claim 13 wherein said projection lens comprises parameters that are determined by:
a) color segments being shifted by a distance of d,
b) a first lens unit having at least one lens with an effective focal length of f,
c) dichroic mirrors being placed on the effective focal plane of the first lens unit, and
d) a tilting angle determined by a tan(d/f)/2, which is less than 90 degrees.

15. The single panel projection system as specified in claim 13 wherein said display panel comprises electronic image processing or optical components that correct distortion caused by the tilting dichroic mirrors.

16. The single panel projection system as specified in claim 12 wherein said self-emitting display panel is comprised of an LED panel or an OLED panel.

17. A single panel display system consisting of a color near-to-eye display system comprising:
a) a display panel having at least two segments that display corresponding color information or at least two display panels that are arranged substantially adjacent to each other and substantially on the same plane, and
b) a lens system having means for combining said at least two segments together to form a full color picture.

18. The single panel display system as specified in claim 17 wherein said display panel is selected from the group consisting of a reflective LCOS panel, a transmissive LCOS panel, a MEMS panel, a HTPS panel, and a TFT LCD panel.

19. The single panel display system as specified in claim 17 wherein said display panel is an emitting panel such as an LED panel or an OLED panel.

20. The single panel display system as specified in claim 17 comprising an illumination system that comprises an LED, OLED or laser.

21. The single panel display system as specified in claim 17 wherein said lens system comprises at least two dichroic mirrors that are tilted at different angles.

22. The single panel display system as specified in claim 21 wherein said display panel further comprises electronic image processing or optical components that correct distortion that is caused by the tilting dichroic mirrors.

23. The single panel projection system as specified in claim 21 wherein said lens system produces a color image directly onto the retina of a viewer's eyes.

24. A single panel projection lens that combines at least two color segment images together into a full color picture comprising:
a) at least one lens, and
b) at least two color selective components that can selectively redirect colors to a substantially same direction.

25. The single panel projection lens as specified in claim 24 wherein said at least two color selective components are comprised of at least two dichroic mirrors that are tilted at different angles.

26. The single panel projection lens as specified in claim 25 wherein said projection lens has parameters that are determined by:
a) color segments being shifted by a distance of d,
b) a first lens unit having at least one lens with an effective focal length of f,
c) dichroic mirrors being placed substantially on the effective focal plane of the first lens unit, and
d) a tilting angle determined by a tan(d/f)/2, which is less than 45 degrees.

27. The single panel projection lens as specified in claim 24 further comprising optical components that correct distortion caused by the tilting dichroic mirrors.

28. The single panel projection lens as specified in claim 27 wherein said optical components comprise tilting or shifting field lenses, an optical prism or a wedge.

29. The single panel projection lens as specified in claim 24 wherein said color selective components are located before, within or after said at least one lens.

30. The single panel projection lens as specified in claim 24 wherein said at least two color selective components are comprised of a grating or a hologram film.
